(19) United States
(12) Patent Application Publication
(10) Pub. No.: US 2006/0267786 A1
(43) Pub. Date: Nov. 30, 2006

(54) SMOKE DETECTION DEVICE

(75) Inventors: Andre Freiling, Klosterseelte (DE); Klaus Schmoetzer, Stuhr (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/420,265

(22) Filed: May 25, 2006

Related U.S. Application Data
(60) Provisional application No. 60/685,266, filed on May 27, 2005.

(30) Foreign Application Priority Data
May 27, 2005 (DE) 10 2005 024 407.6

(51) Int. Cl. G08B 17/10

(52) U.S. Cl. 340/628

(57) ABSTRACT

A device for detecting smoke comprises a hood, in which a smoke detector for detecting smoke is arranged and includes at least one turbulence element in order to generate turbulence at the hood, by disturbing an airstream that flows past the smoke detector by the turbulence element.

### RELATED APPLICATIONS

This application claims the benefit of the filing date of U.S. Provisional Patent Application No. 60/685,266 filed May 27, 2005 and of the German Patent Application No. 10 2005 024 407.6 filed May 27, 2005, the disclosures of which are hereby incorporated herein by reference.

### TECHNICAL FIELD OF THE INVENTION

The invention relates to smoking detection devices.

### BACKGROUND OF THE INVENTION

In aircraft, there are smoke alarm systems in various regions of the aircraft. In the cargo compartment and in toilets, a smoke alarm is issued by smoke detectors that are exposed to environmental air. The (smoke-laden) air reaches the smoke detector by way of convection. Convection not only depends on the thermodynamic conditions but also on the airflow imposed by the air conditioning system. In order to ensure that an adequate quantity of air flows around the smoke detector, several solutions exist.

In cargo compartments, for example, a smoke detector which is installed in the ceiling region in a type of hood is used. A so-called smoke guide plate ensures that smoke reaches into a measuring chamber of the detector rather than diffusing into the upper volume region of the hood.

However, the above-mentioned generally known solution does not take into account thermodynamic and climatic conditions in a cargo compartment with high flow rates in certain air inflow and outflow systems.

### SUMMARY OF THE INVENTION

There may be a need to create a smoke detection device which works reliably even under difficult thermodynamic and climatic conditions encountered in transportation vehicles, such as aircraft and other environmental conditions.

In one example of the invention, smoke guide ridges that are used as turbulence elements as well as a smoke detector are installed in a hood. These smoke guide ridges may be used to generate wake turbulence and/or smoke turbulence. In this way, situations in which smoke moves past the smoke detector without entering its measuring chamber may be prevented. Furthermore, the smoke guide ridges may be used, after the turbulence has been generated, to lead the smoke in a targeted way to the measuring chamber of the smoke detector.

In one example, the ridges are symmetrically arranged in the hood in order to ensure that smoke turbulence creation occurs independently of the direction of the hood. For example, the hood may be arranged on the left hand side or on the right hand side of an air outlet. However, in other examples, asymmetrical solutions may be utilized. In one example, the ridges extend in a substantially perpendicular direction in relation to the direction of flow of an airstream.

### BRIEF DESCRIPTION OF THE DRAWINGS

The drawings provide some examples of the invention.

FIG. 1 depicts a diagrammatic top view of one example of the invention.

FIG. 2 illustrates a cross-sectional view of one example of the invention along the section line A-A of FIG. 1.

FIG. 3 shows a view of another example of the invention.

FIG. 4 illustrates a top view of another example of the invention

FIG. 5 depicts a top view of another example of the invention.

FIG. 6 illustrates a top view of another example of the invention.

### DETAILED DESCRIPTION OF PREFERRED EMBODIMENTS OF THE INVENTION

This detailed description and drawings provide specific examples of the invention, but the invention should not be limited merely to the examples disclosed. Instead, the invention should be limited only by the claims that may eventually issue. Many variations in the invention will be readily apparent to those familiar with the field based on the drawings and description provided. Below, identical or similar components and elements in the different views of the figures have the same reference characters.

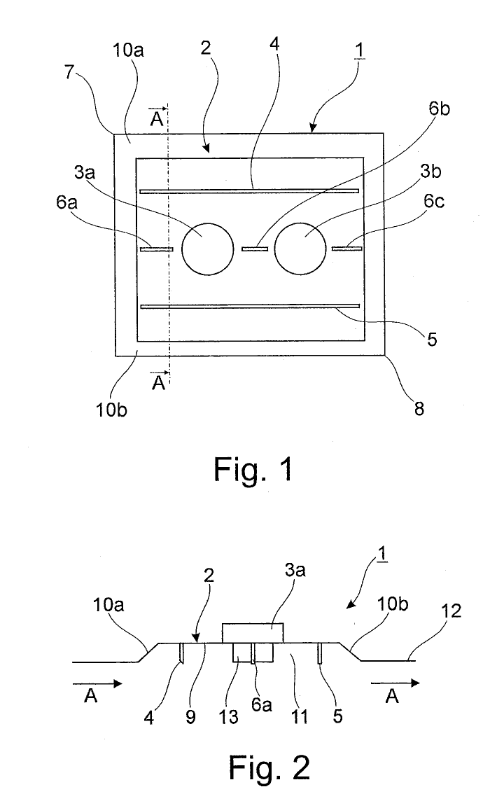

As shown in FIG. 1, in this example, the device 1 comprises a hood 2 in which two smoke detectors 3a, b are arranged. Furthermore, the hood 2 comprises ridges 4, 5 that extend so as to be substantially parallel in relation to each other along the entire length of the hood 2. In this example, the ridge 4 is arranged on one side of the smoke detectors 3, while the ridge 5 is arranged on an opposite side of the smoke detectors 3.

Furthermore, there are additional ridges 6a-6c between the smoke detectors 3a, b, which ridges 6a-6c extend in a substantially parallel direction in relation to the ridges 4, 5. In this example, ridge 6a is located between a left edge 7 of the hood 2 and the smoke detector 3a. Also, ridge 6b is between the smoke detectors 3a and 3b, and ridge 6c is between the smoke detector 3b and a right edge 8 of the hood 2. In this example, the ridges 6a-6c are aligned in a substantially parallel direction in relation to the ridges 4, 5.

As shown in FIG. 2, in this example, the hood 2 comprises a bottom face 9, from which the ridges 4, 5, 6a extend downward so as to be substantially perpendicular. In this example, the bottom face 9 is only interrupted in those regions in which a smoke detector is placed.

As shown in FIG. 2, from the bottom face 9, side faces 10a, b extend outward at a predefined angle (for example, 45°). The side faces 10a, b and the bottom face 9 of the hood 2 form an open space 11. In the installed state, as shown in FIG. 2, the space 11 is open towards the cargo compartment. As shown in FIG. 2, the ridges 4, 6a, 5 are located in the space 11 formed by the side faces 10 and the bottom face 9. In the installed state of this device, the side faces 10a, b are closed off by a ceiling 12.

As shown in FIG. 2, the ridges 4, 5, 6a are arranged such that an airstream A, which flows in the region of the ceiling 12, is distributed in a substantially perpendicular direction by the ridges 4, 5, 6a. This generates turbulence (wake turbulence) in which any smoke contained in the airstream A may be fed in a targeted manner to a measuring chamber 13 of the smoke detector 3a.

Although in FIG. 2, the device is shown mounted flush in the ceiling 12, the device 1 may be mounted in other arrangements. For example, the device may be mounted flush in a sidewall of a cargo compartment.

In the example shown in FIG. 2, the ridges 4, 5 and 6a protrude sufficiently from the bottom face 9 of the hood 2 in the direction of the airstream A such that they do not protrude from the space 11 of the hood 2, which is formed by the side faces 10a-b and the bottom face 9. The arrangement of the ridges and of the smoke detectors is symmetrical in FIG. 2. Depending on the area of application or on the thermodynamic and climatic conditions, an asymmetrical arrangement of the ridges and the smoke detector may also be utilized.

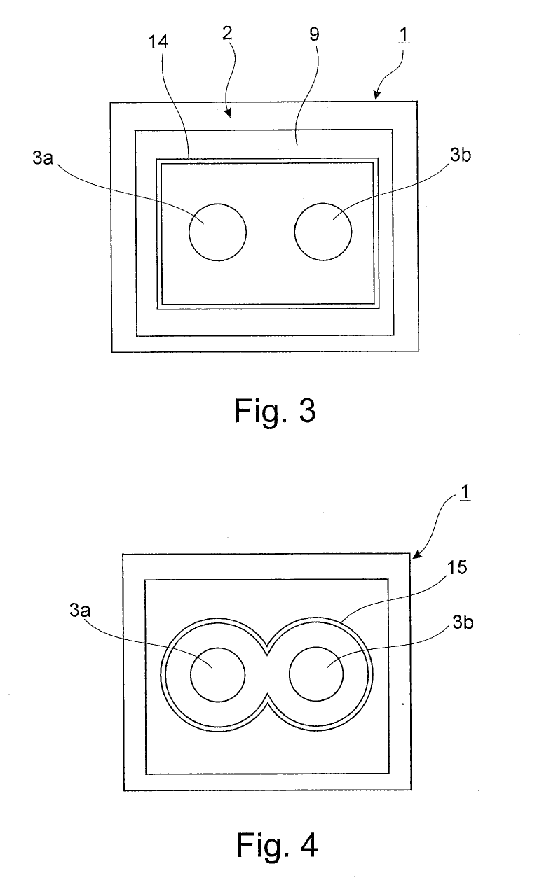

In FIG. 3, which depicts another example of the invention, a top view is shown. In this example, the hood 2 comprises a turbulence element 14 that is rectangular in shape. Other geometric shapes may also be utilized. In this example, the turbulence element 14 is designed to be symmetrically arranged around the smoke detectors 3a, 3b. Additionally, the turbulence element extends, in the direction of the cargo compartment in a similar manner as with the ridges of FIG. 2, from a bottom face 9 of the hood 2 such that turbulence is created in an airstream A that flows in the region of the ceiling. The turbulence element 14 may be made from four separate ridges or in other examples, it may be an integrated component or unitary. In this examples, ridges form the turbulence elements.

In FIG. 4, another example of the invention is shown. In this example, a turbulence element 15 is designed in the shape of two circular arcs that are interconnected at their ends. Other geometric shapes may be utilized. The turbulence element 15, in this example, is symmetrically arranged around the smoke detectors 3a, 3b.

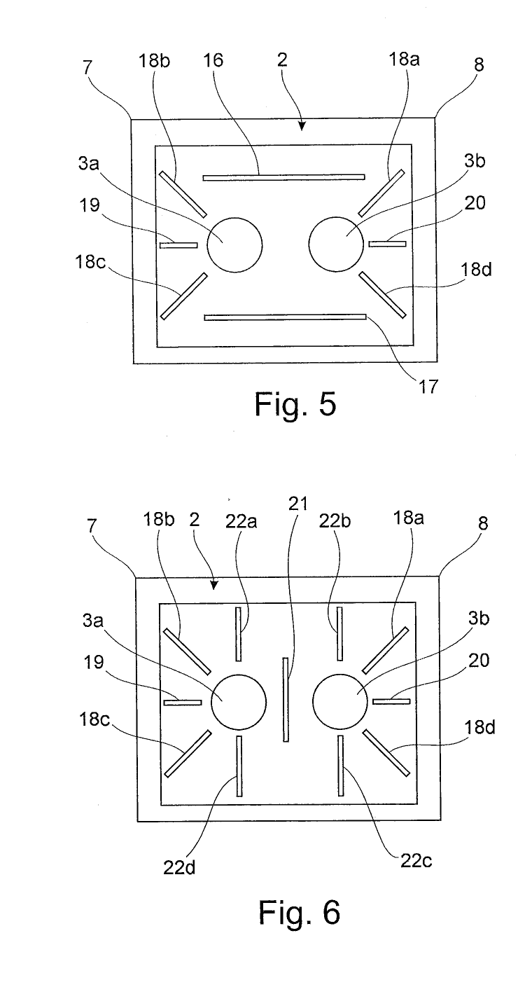

FIG. 5 shows another example of the invention, in which ridges 16, 17 are arranged in a substantially parallel direction in relation to each other on opposite sides of the smoke detectors 3a and 3b in the hood 2. In this example, additional ridges 18a-18d extend substantially symmetrically around the smoke detectors 3a, 3b at a predefined angle to the ridges 16 or 17. The hood 2 also contains additional ridges 19, 20 that extend in a substantially parallel direction in relation to the ridges 16, 17. In this example, ridges 19, 20 are shorter than the ridges 16, 17 and extend essentially in one line. In other examples, the ridges 19, 20 may be longer than the ridges 16, 17.

In FIG. 6, another example of the invention is shown. In this device, there is a an additional ridge 21 between the smoke detectors 3a, 3b. In addition to the ridges 18a-18d and 19, 20, the hood 2 also includes further ridges 22a-22d which are arranged in a substantially parallel direction in relation to each other and which extend substantially parallel to the ridge 21.

In FIGS. 5 and 6, the ridges 18b, 19, 18c extend between the left edge 7 of the hood 2 and the smoke detector 3a, while the ridges 18a, 20, 18d extend between the right edge 8 of the hood 2 and the smoke detector 3b.

Although the invention has been described above with reference to exemplary embodiments, it goes without saying that modifications and alterations can be made without leaving the scope of protection of the invention, in particular in relation to the arrangement of the ridges or the turbulence elements in the hood 2. The arrangement and alignment of the turbulence elements and the ridges within the hood 2 depend on the particular thermodynamic and climatic conditions that prevail in a cargo compartment of an aircraft.

According to these examples, only two smoke detectors are provided in the hood of the smoke detection device. However, any other desired number of smoke detectors may be installed in the hood. Furthermore, the material of the turbulence elements and of the hood can for example be metal, plastic or any other suitable material.

In addition it should be pointed out that “comprising” does not exclude other elements or steps, and “a” or “one” does not exclude a plural number. Furthermore, it should be pointed out that characteristics or steps which have been described with reference to one of the above embodiments can also be used in combination with other characteristics or steps of other embodiments described above. Reference characters in the claims are not to be interpreted as limitations.

Alternative combinations and variations of the examples provided will become apparent based on this disclosure. It is not possible to provide specific examples for all of the many possible combinations and variations of the embodiments described, but such combinations and variations may be claims that eventually issue.

What is claimed is:

1. A device for detecting smoke, comprising:
a hood;
a smoke detector for detecting smoke; and
at least one turbulence element, wherein the smoke detector and the at least one turbulence element are located in the hood and arranged such that at least one turbulence element disturbs an airstream that flows past the smoke detector.

2. The device of claim 1, wherein the hood comprises:
a bottom face;
side faces such that the side faces extend outward from the bottom face in order to form
an open space.

3. The device of claim 2,
wherein the smoke detector is attached to the bottom face of the hood and partly protrudes trough said hood.

4. The device of claim 2,
wherein those side faces that point to the direction of the airflow extend outward from the bottom face at an angle.

5. The device of claim 2,
wherein the at least one turbulence element extends away from the bottom face of the hood so as to be substantially perpendicular, and the airstream that flows past the smoke detector flows substantially perpendicular to the at least one turbulence element.

6. The device of claim 1,
wherein the at least one turbulence element is located in the hood so as to be arranged substantially around the smoke detector.

7. The device of claim 1, further comprising:
a plurality of turbulence elements such that the plurality of turbulence elements are arranged in the hood so as to be substantially parallel in relation to each other.

8. The device of claim 1,
wherein the turbulence element does not protrude from the hood.

9. The device of claim 1,
wherein the turbulence element is formed as a ridge.

10. The device of claim 1,
wherein the turbulence element is of a geometric shape.

11. The device of claim 10, wherein the geometric shape is round.

12. The device of claim 10, wherein the geometric shape is rectangular.

13. The device of claim 1, wherein the device is utilized in an aircraft, the device being attachable such as to be recessed in region of an aircraft in order to create turbulence in an airstream that flows in the region and for detection of smoke in the airstream.

14. The device of claim 13, wherein the region includes a wall.

15. The device of claim 13, wherein the region includes a ceiling.
